(19) United States
(12) Patent Application Publication
(10) Pub. No.: US 2009/0007361 A1
(43) Pub. Date: Jan. 8, 2009

(54) Spatula Device for Spreading Grout and Other Filler Material Over Curved Surfaces

(76) Inventor: Miguel Angel Gonzalez, Bonnyrigg Heights (AU)

Correspondence Address: MICHAEL MOLINS;MOLINS & CO., SUITE 5, LEVEL 6, 139 MACQUARIE ST, SYDNEY NSW, 2000, AU

(21) Appl. No.: 11/772,824

(22) Filed: Jul. 3, 2007

(51) Int. Cl. B05C 17/10

(52) U.S. Cl. 15/245.1; 52/742.16

(57) ABSTRACT

A spatula device (10) has a handle portion (12) and a blade portion (14) connected to one end of the handle portion and so as to form a longitudinal axis of the spatula device. The blade portion has a permanent curvature which is radiused about a line transverse of the longitudinal axis, whereby the spatula device may be used to apply grout and other filler material to a curved surface without the user having to bend the blade portion.

### FIELD OF THE INVENTION

The present invention relates to an improved spatula device and method utilizing said device for spreading grout and other filler material over curved or angled surfaces, say, where two laterally curved cornices meet end to end along one side of a room, for the purpose of disguising the join or small gap therebetween.

Although the invention will be hereinafter described with reference to a spatula device for use in spreading grout over a join between the adjoining ends of a pair of “in line” cornices that are laterally curved, it is to be understood that the invention is not limited thereto but has wider application. For example, the improved spatula device may be used in the repair industries for land vehicles and marine vessels. Also, it is to be understood that the phraseology and terminology employed herein are for the purpose of description only and should not be regarded as limiting.

### BACKGROUND OF THE INVENTION

Conventional spatulas used by carpenters, builders and handymen to fill in small gaps or surface irregularities between the adjoining ends of a pair of elongated structural members, such as cornices and skirting boards, comprise a straight handle portion and an enlarged blade portion expanding out from one end of the handle portion. The blade portion is generally flat and, while it is ideally suited to applying grout to a flat surface to disguise a small gap therein, it is poorly suited to applying grout to a curved surface.

The ability of conventional “flat blade” spatulas to apply grout to a curved surface is very much dependent on the intrinsic capacity of the blade to bend under force applied by the user's hand. However, the flexibility of the blade of conventional spatulas may be very low for metal blade spatulas but better for plastic blade spatulas. Furthermore, conventional spatulas do not retain the molecular memory of the bent shape of their blades, and so when they are used to spread grout over a curved surface, the blades must be bent by the user on each occasion that grout is applied. This may be tiring for the user and may not always result in evenly and uniformly spread grout over a small gap in the curved surface.

It has been found by the present inventor that, by creating a permanent curve transversely across the blade of a spatula device, the new spatula device has improved functionality and reliability.

### SUMMARY OF THE INVENTION

It is an object of the present invention to overcome or substantially ameliorate the disadvantages and shortcomings of the aforementioned prior art, or at least provide a useful alternative.

It is another object of the present invention to provide an improved spatula device that is simple and inexpensive to manufacture, can be easily used by even the untrained user, and that results in the filling of a join or small gap between the adjoining ends of laterally curved cornices and the like with grout or a filler material in a way that disguises the join.

According to the present invention there is provided a spatula device comprising a handle portion and a blade portion connected to one end of the handle portion and so as to form a longitudinal axis of the spatula device, the blade portion having a permanent curvature which is radiused about a line transverse of the longitudinal axis, whereby the spatula device may be used to apply grout and other filler material to a curved surface without the user having to bend the blade portion.

Preferably, the blade portion is enlarged and expands out from the handle portion.

It is preferred that the spatula device is manufactured as a single piece, and may be fabricated of plastic.

There has been thus outlined, rather broadly, the more important features of the invention in order that the detailed description thereof that follows may be better understood and put into practical effect, and in order that the present contribution to the art may be better appreciated. There are additional features of the invention that will be described hereinafter. As such, those skilled in the art will appreciate that the conception, upon which the disclosure is based, may be readily utilized as the basis for designing other structures and methods for carrying out the objects of the present invention. It is important, therefore, that the broad outline of the invention described above be regarded as including such equivalent constructions in so far as they do not depart from the spirit and scope of the present invention.

### SUMMARY OF THE DRAWINGS

The invention will be better understood and objects other than those set forth above will become apparent when consideration is given to the following detailed description thereof. Such description makes reference to the accompanying drawings, in which:

FIG. 1 is a plan view of a preferred spatula device of the invention,

FIG. 2 is a side view of the spatula device shown in FIG. 1,

FIG. 3 is an isometric view of the spatula device shown in FIGS. 1 and 2,

FIG. 4 is a perspective view of the spatula device of FIGS. 1 to 3 in use (at different stages A and B) filling a small gap between adjoining ends of a pair of adjacent “in line” cornices, and

FIG. 5 is another perspective view of the spatula device of FIGS. 1 to 3 in use filling a small gap between ends of cornices meeting at a corner of a room.

### DESCRIPTION OF PREFERRED EMBODIMENTS

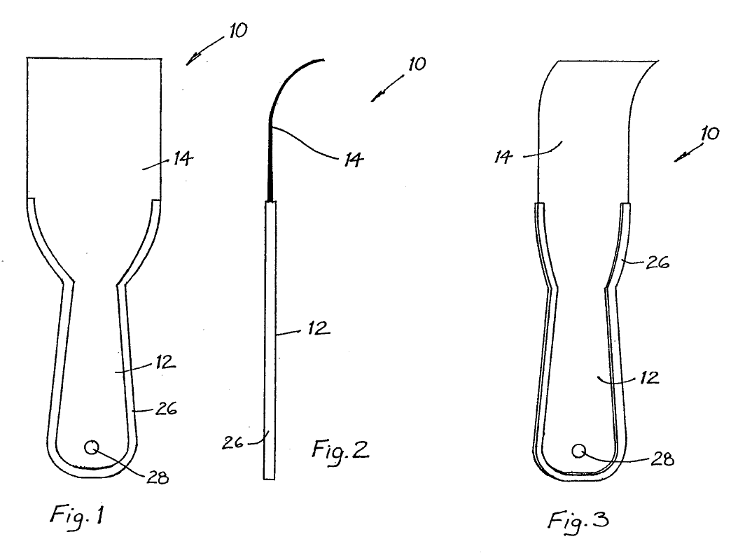

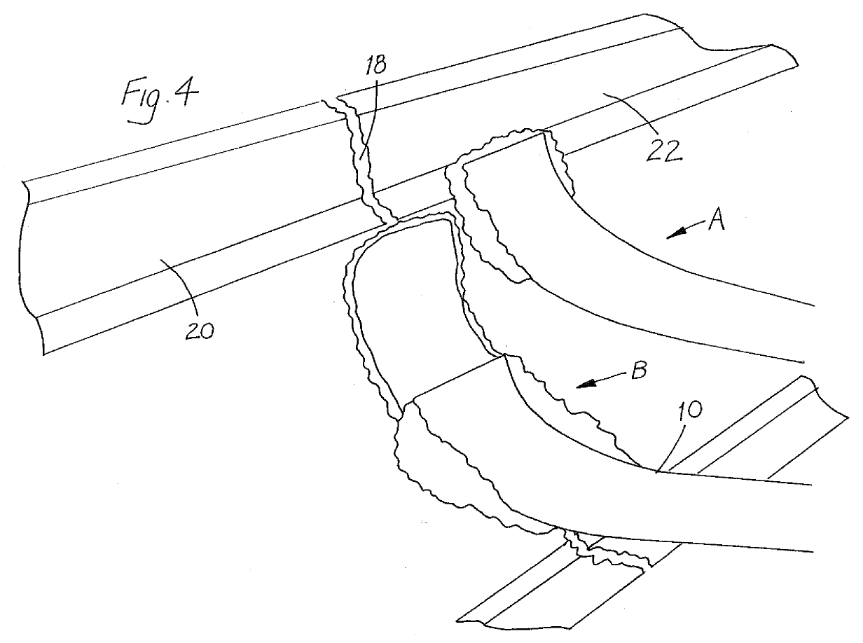

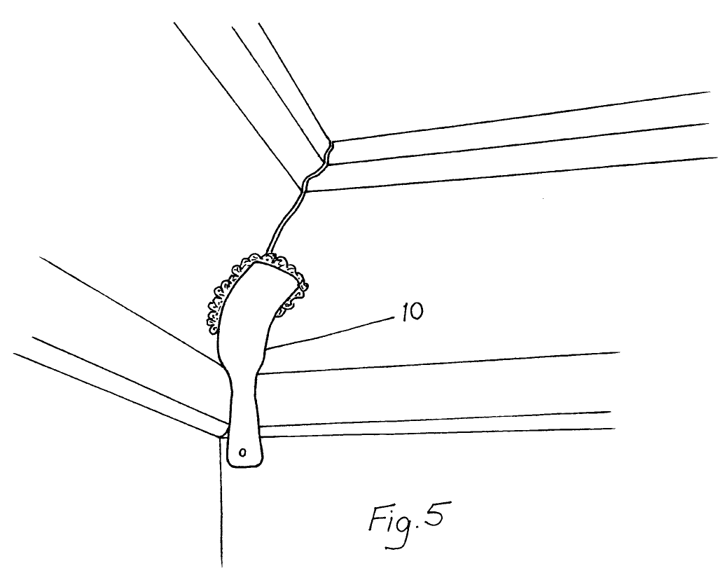

With reference now to the above summarized drawings, and in particular to FIGS. 1 to 5 thereof, an improved spatula device embodying the principles and concepts of the present invention and generally designated by the reference numeral 10 will now be described.

The spatula device 10 has a handle portion 12 which is integrally connected at one end thereof to a blade portion 14, say, as a result of being manufactured in a plastic moulding operation.

The blade portion 14 is enlarged and expands outwardly from the handle portion 12, but is thinner than the handle portion so that it may be capable of some flexing movement during use.

There is a reinforcing edge member 26 surrounding the edges of the handle portion 12 and part of the blade portion 14 to add strength to the device. A hole 28 is formed in the handle portion 12 to assist in hanging the device on a hook or the like when not in use.

Together, the handle and blade portions 12, 14 define a longitudinal axis of the spatula device, the blade portion having a permanent curvature which is radiused about a line transverse of the longitudinal axis, whereby the spatula device may be used to apply grout and other filler material to a curved surface without the user having to bend the blade portion. The permanence in the curvature of the blade portion is the result of the manufacturing process.

In use, the spatula device 10 can advantageously apply grout to a join 18 or small gap between the ends of a pair of adjoining, laterally curved, cornices 20, 22 extending along a wall of a home. The curvature of the blade portion of the spatula device 10 is similar to the curvature of the cornices and so the user only needs to wipe the grout, which has been loaded onto the blade portion, over the join without exerting much hand pressure which might otherwise be needed to bend the flat blade portion of a conventional spatula.

Application and spreading of the grout in the aforementioned manner with the spatula device 10 leads to a smoother and more seamless grouted surface over the join than would result from use of conventional spatulas.

It will be readily apparent to persons skilled in the art that various modifications may be made in details of design and construction of the improved spatula device described above without departing from the scope or ambit of the present invention.

The description of the prior art herein is not to be taken as implying that the prior art forms part of the common general knowledge in this field before the filing date of this patent application.

I claim:

1. A spatula device comprising a handle portion and a blade portion connected to one end of the handle portion and so as to form a longitudinal axis of the spatula device, the blade portion having a permanent curvature which is radiused about a line transverse of the longitudinal axis, whereby the spatula device may be used to apply grout and other filler material to a curved surface without the user having to bend the blade portion.

2. The spatula device of claim 1 wherein the blade portion is enlarged and expands out from the handle portion.

3. The spatula device of claim 1 wherein the spatula device is manufactured as a single piece.

4. The spatula device of claim 3 wherein the spatula device is fabricated of plastic.

5. The spatula device of claim 1 wherein the blade portion is thinner than the handle portion.

6. A method of applying grout to a gap between the ends of adjoining, laterally curved, cornices along a wall of a home, the method comprising the steps of:
(a) providing the device of claim 1,
(b) applying grout to a convexly curved side of the blade portion, and
(c) wiping the grout into the gap by holding the handle portion and moving the device over the gap so that the grout enters and fills the gap.

7. A spatula device substantially as hereinbefore described with reference to the accompanying drawings.
